(19) United States
(12) Patent Application Publication
(10) Pub. No.: US 2006/0091614 A1
(43) Pub. Date: May 4, 2006

(54) Reduction in the generation of heat under PTFE sealing element

(76) Inventor: Lourenco Agnello Oricchio JR., Sao Paulo (BR)

Correspondence Address: ARENT FOX PLLC, 1050 CONNECTICUT AVENUE, N.W., SUITE 400, WASHINGTON, DC, 20036, US

(21) Appl. No.: 10/979,801

(22) Filed: Nov. 3, 2004

(51) Int. Cl. F16J 15/32

(52) U.S. Cl. 277/549

(57) ABSTRACT

This abstract refers to a patent of invention for sealing element pertaining to the field of sealing elements, which was improved considering its hydrodynamic sealing and for extending its useful life; this element is basically composed of PTFE circular-crown-shaped body (10), which consists in: sealing zone (12); intermediary coupling zone (13), which is folded upon the assembling of the element against the surface to be sealed; peripheral settlement zone (14); and device (15) destined to provide more flexibility to the PTFE sealing element (10), basically composed of a series of parallel grooves, internal (16) and external (17), located along the perimeter of the internal and external surfaces of the intermediary coupling zone (13) of the PTFE sealing element (10).

### BACKGROUND OF THE INVENTION

1. Field of the Invention

This descriptive report refers to a patent of invention for a sealing element pertaining to the field of sealing elements made of polytetrafluoroethylene, PTFE, which was improved considering its hydrodynamic sealing and for extending its useful life.

2. Description of the Related Art

There are available sealing elements of polytetrafluoroethylene, PTFE, composed of a circular-crown-shaped body provided with the sealing surface, located in the inner section of this body, where the hydrodynamic sealing is located; said body is provided with an intermediary section, destined to fold upon the assembling of the sealing against the surface to be sealed; and by a peripheral settlement region.

Sealing elements with this type of construction allow the obtainment of other sealing devices, such as retainers and similar components, which are basically composed of: PTFE sealing element; rubber auxiliary sealing element; and frame or other form of construction for fastening the PTFE sealing element, using flanges, for instance. This sealing device is destined specifically to automotive applications.

The PTFE sealing element functions adequately. However, the operational conditions of modern motors, such as rotation, temperature, cooling, and other functions cause the carbonization of the lubricant oil in the interface between the sealing surface of the PTFE sealing element and the surface of the axle sealed. The carbonized oil clogs the grooves for hydrodynamic sealing. This causes an undue sealing as a whole, commitment the integrity of the PTFE sealing element, which has its useful life reduced, among other factors. As a result, the mechanism sealed is jeopardized.

### SUMMARY OF THE INVENTION

Thus, this invention is intended to provide a PTFE sealing element that resolves the problem exposed above.

Another objective of this invention is to provide a PTFE sealing element that, despite the fact of resolving the problems of those currently in use, will not have complicated or undesirable construction and manufacturing process.

Another objective is to promote a PTFE sealing element with adequate cost.

Therefore, in light of the problems listed above and in order to resolve them, under the objectives listed, we developed the improvement of the PTFE sealing element object of this patent of invention, the construction, operation, and benefits of which are described below based on the drawings attached hereto, to wit:

### BRIEF DESCRIPTION OF THE DRAWINGS

FIG. 1 demonstrates the detail of a sealing device with PTFE sealing element as of the invention, in cut view;

FIG. 2 demonstrates the detail of the PTFE sealing element as of the invention, in cut view; and

FIG. 3 demonstrates the detail of another possibility for the PTFE sealing element, in cut view.

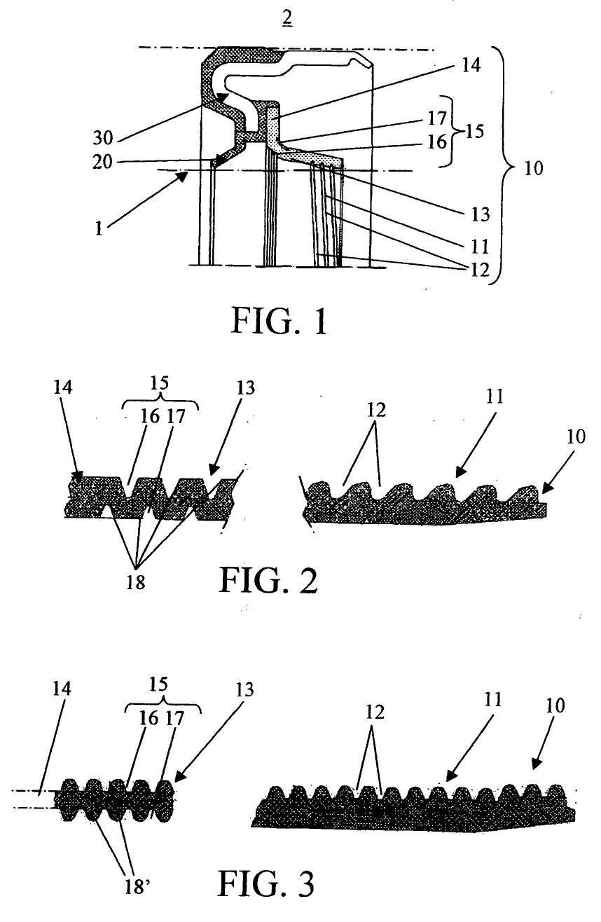

### DESCRIPTION OF THE PREFERRED EMBODIMENTS

Pursuant to the figures listed above, the polytetrafluoroethylene sealing element, PTFE, object of this invention is destined to seal the interstice between, for the sake of example, an axle 1 and a surface 2 adjacent and around the axle, being basically composed of a PTFE circular-crown-shaped body 10, with: sealing zone 11, located in the inner region of the body and with hydrodynamic sealing 12 in the format of helicoid groove; intermediary coupling zone 13, folded upon the assembling of the element against the surface to be sealed, which may be turned towards the internal or external side of the motor; and peripheral settlement zone 14.

The sealing element 10 with this type of construction is used to composed sealing devices, such as retainers and similar components, basically composed of: PTFE sealing element 10; rubber auxiliary ring sealing element 20 destined to impede the entry of grime in the region sealed and which incorporates the peripheral settlement zone 14 of the PTFE sealing element 10; and ring frame 30, which incorporates the rubber auxiliary sealing element 20.

This invention consists in providing a device 15 destined to provide more flexibility to the PTFE sealing element 10, basically consisting of a series of parallel grooves, internal 16 and external 17, located along the perimeter of the internal and external surfaces of the intermediary coupling zone 13 of the PTFE sealing element 10.

The PTFE sealing element 10, which counts on a flexibility device 15, has usual functioning, i.e., the sealing surface 11 and the hydrodynamic sealing 12 are sealed against the surface of the axle 1 in a manner that is already known. The flexibility device 15 improves the dynamic functions of the PTFE sealing element 10 in relation to the surface sealed 1.

This improvement in the PTFE sealing element 10 in relation to the surface sealed 1 minimizes the generation of heat in the interface between the sealing surface 11 and the surface sealed 1, which allows the substantial reduction of the carbonization of lubricant oil in the region, consequently the substantial, or elimination, of the clogging in the hydrodynamic sealing 12.

Tests carried out in the appropriate test chamber, wherein an axle was assembled and spun at 6500 rpm, against which a PTFE sealing element was constructed according to the invention, and pulverized (besprinkled) with oil at 150° C., demonstrated better dynamic functioning of the sealing element in relation to the axle, and significant reduction in the carbonization of the oil in the interface sealing-axle, and reduction in the clogging of the hydrodynamic sealing.

Therefore, the problem observed with the hydrodynamic sealing, as aforementioned, is resolved by the PTFE sealing element according to this invention, considering that the methods and prices for construction and manufacture will not be negatively affected.

Within the basic construction aforementioned, the PTFE sealing element object hereof may present modifications without affecting the scope of protection requested.

Thus, the internal 16 and external 17 grooves constituting the flexibility device 15 of the PTFE sealing element 10 may be concentric and de-phased in relation to each other, as of FIG. 2.

Optionally, the internal 16 and external 17 grooves constituting the flexibility device 15 of the PTFE sealing element 10 may be concentric and coincident on in relation to the other, as of FIG. 3.

The internal 16 and external 17 grooves constituting the flexibility device 15 of the PTFE sealing element 10 may define sharp edges 18 in relation to the internal and external surfaces of the PTFE sealing element 10, as of FIG. 2, or round edges 18′, as of FIG. 3.

In order to improve the flow of the oil between the sealing element 10 and the axle 1, were constructed geometry with concordance between the sealing zone 11, located in the internal region of the body, and hydrodynamic sealing in the form of helicoid groove 12.

What is claimed is:

1. REDUCTION IN THE GENERATION OF HEAT UNDER PTFE SEALING ELEMENT, basically consisting in a PTFE circular-crown-shaped body (10) composed of: sealing zone (11), located in the internal region of the body and provided with hydrodynamic sealing (12) in the form of helicoid groove; intermediary coupling zone (13) and peripheral settlement zone (14), characterized by the fact of bearing a device (15) destined to provide more flexibility to the PTFE sealing element (10), which basically consists in a series of parallel grooves, internal (16) and external (17), located along the perimeter of the internal and external surfaces of the intermediary coupling zone (13) of the PTFE sealing element (10), which is folded upon the assembling of the element against the surface to be sealed, which may be turned towards the internal or external side of the motor.

2. REDUCTION IN THE GENERATION OF HEAT UNDER PTFE SEALING ELEMENT, as of claim 1, characterized by the fact that the grooves, internal (16) and external (17), constituting the flexibility device (15) of the PTFE sealing element (10) are concentric and de-phased in relation to each other.

3. REDUCTION IN THE GENERATION OF HEAT UNDER PTFE SEALING ELEMENT, as of claim 1, characterized by the fact that the grooves, internal (16) and external (17), constituting the flexibility device (15) of the PTFE sealing element (10) are concentric and coincident in relation to each other.

4. REDUCTION IN THE GENERATION OF HEAT UNDER PTFE SEALING ELEMENT, as of claim 1, characterized by the fact that the grooves, internal (16) and external (17), constituting the flexibility device (15) of the PTFE sealing element (10) define sharp edges (18) in relation to the internal and external surfaces of the PTFE sealing element (10).

5. REDUCTION IN THE GENERATION OF HEAT UNDER PTFE SEALING ELEMENT, as of claim 1, characterized by the fact that the grooves, internal (16) and external (17), constituting the flexibility device (15) of the PTFE sealing element (10) define round edges (18′) in relation to the internal and external surfaces of the PTFE sealing element (10).

6. REDUCTION IN THE GENERATION OF HEAT UNDER PTFE SEALING ELEMENT, as of claim 1, 2, 3, 4, or 5, characterized by the fact of composing geometry with concordance (round edges) between the sealing element (10) and the axle (1), and between the sealing zone (11), located in the internal region of the body, and hydrodynamic sealing in the form of helicoid groove (12).
